(19) United States
(12) Patent Application Publication
(10) Pub. No.: US 2022/0362859 A1
(43) Pub. Date: Nov. 17, 2022

(54) CONVERSION ASSEMBLY FOR MANUAL LATHES, MILLS, GRINDERS, AND OTHER MANUALLY-OPERATED MACHINE TOOLS

(71) Applicants: Gary A. Maier, Lutz, FL (US); Jaime R. Maier, Brandon, FL (US); Eric M. Maier, Dade City, FL (US)

(72) Inventors: Gary A. Maier, Lutz, FL (US); Jaime R. Maier, Brandon, FL (US); Eric M. Maier, Dade City, FL (US)

(21) Appl. No.: 17/317,515

(22) Filed: May 11, 2021

(51) Int. Cl. B23B 25/00; B23Q 1/01

(52) U.S. Cl. CPC B23B 25/00; B23Q 1/017; B23B 2260/03; B23B 2260/072

(57) ABSTRACT

A conversion assembly for affixing a modern guideway to a manually operated machine tool guideway in a nondestructive manner. The conversion assembly mates to the existing machine tool guideway using surface tension via non-destructive compressive and/or tensile forces in order provide a suitable support surface upon which a modern guideway can be affixed.

### CROSS-REFERENCE TO RELATED APPLICATION

Pursuant to 35 U.S.C. § 119(e), this application claims the benefit of U.S. Provisional Patent Application Ser. No. 63/023,074, filed on May 11, 2020, the entire contents of which are incorporated herein by this reference.

### BACKGROUND

### 1. Field of Invention

The present disclosure relates generally to the field of machine tools such as lathes and milling machines, and more particularly, to a conversion assembly for manually-operated machine tools to modernized computer-controlled machine tools.

### 2. Description of Related Art

Machine tools are mechanical devices that move tools and workpieces in relation to each other to craft useful articles from the workpiece. Generally, manually-operated machine tools include a spindle and one or more axes of movement. The spindle is motorized and either holds a tool bit such as a drill, wheel, or end mill, but also may be used to hold a workpiece. In the latter case, the axes of movement are used to hold the tool bit while the workpiece is rotated by the spindle. In all cases, the axes of movement provide a way to bring a tool bit to the workpiece in order to change the workpiece by removing material from it. It is very similar to a craftsman using a chisel (tool bit) to shape a workpiece.

The typical axes of movement are configured orthogonally as: Z, X, and Y. The Z axis of movement is a movement toward and away from the spindle's axis of rotation. The X and Y axis are arranged to move perpendicular to the Z axis, as well as perpendicular to each other. These movements and their orientations provide a three dimensional workspace in which to shape workpieces.

Common to lathes, mills, grinders, and other manually-operated machine tools, these axes are installed upon the machine tool and held in place using an industry-standard axis foundation known as a “guideway(s)”. The function of a guideway is to provide a reliable foundation upon which an axis may travel to and fro without deviating from the straight line which constitutes its axis.

Much effort has been spent on the design, manufacture, and maintenance of guideways. Since machine tools must be constructed to be stronger than the workpieces they are used to alter, they are often very heavy. Furthermore, it is the goal of machine tool builders to manufacture the machine tool to maintain the 90-degree (perpendicular) relationships between the X, Y, and Z axes. Generally speaking, the better a machine tool holds perpendicularity, the better quality the machine tool, referred to in the industry as the measure of “accuracy” and “repeatability”.

Combining this heavy nature with the goals of accuracy and repeatability, an axis is constructed to be tightly-fitted to its respective guideway. Of course, the guideway must also enable to and fro movement of the axis. As a result of this to and fro movement and the tight-fit, the guideways wear with use. Several methods are employed to re-tighten guideways as they wear, but eventually those methods cannot completely tighten a guideway that demonstrates out-of-tolerance wear or that otherwise demonstrates wear beyond its useful life.

In the industry, accuracy and repeatability are valued more than any other feature of a machine tool. Therefore, the challenge is placed upon the manufacturers of all machine tools to design them to not only have accuracy and repeatability, but also to maintain this accuracy and repeatability while wearing slowly.

Over the past 100 or so years, the choice of design for manually-operated machine tool manufacturers has been to use a tightly-fitted, metal-on-metal “sliding” relationship between a guideway(s) and its respective axis. In addition to this choice, and critical to it, the manufacturers also install lubricators, which force thick and sticky oil in between the metal-on-metal contact points of the guideway and axis. This is known in the industry as an “hydraulic bearing”. Due to its incompressibility, the oil forms a barrier between the metal-on-metal sliding surfaces and acts as a buffer between each sliding metal guideway(s) and its respective metal axis. However, because the guideways cannot be sealed, the oil is eventually squeezed out from between the surfaces constituting the guideway. If the operator is diligent, the oil barrier can be rejuvenated before the metal surfaces begin to negatively impact one another by direct bearing and ensuing wear. Unfortunately, this maintenance is often overlooked and for too long. Additionally, tiny metal particles created while machining workpieces can “float” in between the two sliding surfaces via the oil. This too can lead to negative impacts of the guideway surfaces, causing grinding wear between machine components.

Also throughout the years, manufacturers have designed numerous styles of guideways to either improve accuracy or to increase rigidity. They are named based upon their shape and include dovetail, box, and “V” as the most common styles.

More recently, many machine designers have moved from using metal-to-metal sliding guideways in favor of more easily-maintained, replaceable, and lower-friction modular guideways herein referred to as “modern guideways”. Their adoption in the manufacture of machine tools has been almost exclusively for computer-controlled machine tools. Originally, machine tools were entirely manually operated. Eventually, motors were installed to rotate the spindles, and later, motors were installed to move the axes. With the invention of the computer, these motors were placed under a computer's control. A machine tool which is controlled by computer is referred to as a “CNC,” whereas a manually-operated machine tool is referred to as a “manual”.

Most machine tool shops use CNC machine tools for time-savings, cost-savings, accuracy, and repeatability. However, manually-operated machine tools not only still exist, but can be found just about anywhere a CNC machine tool can be found. Most of the manually-operated machine tools continue to be manufactured using sliding metal-to-metal guideways. This is due to two factors: cost and need. 1) Retooling to accommodate modern guideways can be very high; and 2) The relatively slow movement of human operators is served very well using the traditional sliding metal guideway, leaving their lubrication and care in the hands of the user.

Recently, there has been significant interest in utilizing CNC machines since they have become more cost-effective than in prior years. This is due largely to the drop in prices of computer equipment and the numerous machine manufacturers which have appeared in the marketplace after the adoption of the modern guideway. Since the computer has become ubiquitous, machinists and hobbyists alike have become increasingly interested in adding computer-controlled capabilities to their manually-operated machine tools. Such conversions, however, either require permanent modifications that severely degrade the manually-operated guideway(s), or render the machine without manual operation. For most hobbyists and machinists, any one of these reasons can make a conversion entirely unacceptable. Ideally, an individual would like to have both a computer-controlled machine tool and a manually-operated machine tool. Space constraints and/or cost prevent most machinists from acquiring a second machine tool.

Even though there are many machine tools which utilize the modern guideway(s), this does not mean that these machine tools are all well-built with respect to accuracy and repeatability. This is usually the fault of a lack of quality in the foundational castings: either design, process, materials of construction, and/or finish. This fact is well-known in the art, and gives rise to the desire to convert the well-built manually-operated machine tool into a computer-controlled machine tool. However, the conversions known in the art leave much to be desired.

A rough description of such a conversion is “putting motors on the handles”. In other words, simply turning the manually-operated handles with computer-controlled motors. This leads to disastrous results for most manually-operated machine tools in the form of extreme wear-and-tear of the guideways. This also reduces the aftermarket value of the manually-operated machine. In fact, few machinists would consider buying a manually-operated machine tool which has been converted to computer-control for fear that the machine is completely worn out.

To further hinder such conversions as currently known in the art, the very nature of a CNC machine tool means a converted manually-operated machine tool will experience workload for which it was never designed. The castings, bearings, lubricators, and axes guideway(s) will be rapidly degraded by a typical conversion from manual to CNC. For example, a manually-operated machine tool manufacturer originally designed and built the manually-operated machine tool with the idea a human operator would control the movements of the axes via manually-turned handles. This means weight-shifting and load-bearing would occur at the rate of human movement. The wear on surfaces, and accommodating of the same, was designed into the machine tool with this in mind. To compare the wear on a machine tool between a manually-operated machine tool and a CNC machine tool would be akin to the difference between an economy passenger car and an Indianapolis 500 race car.

Therefore, once the manually-operated machine tool is converted to a CNC machine tool, the machine tool weight-shifts, load-bears, and displaces lubrication up to hundreds of times the rate of a human operator. Acceleration, deceleration, and directional-change forces similarly increase. Further, given that the manually-operated machine tool was never meant to be operated so quickly, lubrication ports on manually-operated machine tools are not suited for the computer-controlled operations and converted manually-operated machine tools often suffer from a lack of proper lubrication. It is not uncommon for a manually-operated machine tool to be completely worn out within six months of a conversion to computer-control if used in a commercial environment. From the manually-operated machine tool's perspective, six months under computer-control can translate to decades of abusive manual operation.

Prior to the conversion assembly disclosed herein, conversions from manually-operated to CNC would doom the manually-operated machine tool to a severely shortened-life. Further, it would reduce its resale value, and possibly even render the machine tool completely worthless. When visiting a machine tool shop, it is not uncommon to see decommissioned manually-operated machines which were converted to computer-control and have subsequently become unusable. The conversion assembly disclosed herein may also be used to restore such degraded machines back to useful service.

The conversion assembly disclosed herein comprises a unique method for the conversion of a manually-operated machine tool to a computer-controlled machine tool without permanent modifications to the manually-operated machine tool and without causing wear upon the manually-operated machine tool, and allows for the restoration and return-to-service of previously worn-out manually-operated machine tools. In one embodiment, the present conversion assembly provides for modernizing the guideways to properly and effectively computer-control a manually-operated machine tool without causing any degradation or alteration of the original manually-operated guideways.

Various embodiments of the conversion assembly disclosed herein relate to the conversion of manually-operated machine tools such as lathes, mills, and grinders, both vertical and horizontal, such that: 1) their usefulness may be significantly extended; 2) their precision features may be fully utilized while being protected from further degradation; 3) they may be upgraded with computer-controlled components without suffering from the wear-and-tear associated with such upgrades already known in the art; or 4) they may be returned to useful service after having been declared useless due to excessive or otherwise unacceptable wear.

### SUMMARY OF THE PREFERRED EMBODIMENTS

The conversion assembly described herein comprises a unique device for the conversion of a manually-operated machine tool to a computer-controlled machine tool without permanently modifying the manually-operated machine tool and without causing premature wear upon the manually-operated machine tool.

In one embodiment, the conversion assembly disclosed herein provides proper industry-standard surfaces suitable for professional computer-controlled machine tools. Unlike conversions already known in the art, the present conversion assembly can not only provide for the complete conversion of the manually-operated machine tool for professional computer-control, but can do so without permanent modifications to the manually-operated machine tool. Moreover, the conversion assembly is easily removed, and the machine tool can be returned to its original manually-operated form without any signs of wear from having had the conversion assembly installed previously, regardless of duration.

The original manually-operated guideways also remain as they were, free from wear and other degradation from usage of the conversion assembly. Additionally, after removal of the conversion assembly, the manually-operated machine tool may be resold on the aftermarket as an unmodified manually-operated machine tool. This is significant because manually-operated machine tools which have been converted to computer-control are well-known to be undesirable in the used marketplace because of the extraordinary wear manually-operated machine tools suffer after a typical conversion to computer-control without the benefits of the conversion assembly.

Further, many manually-operated machine tool owners have no desire to forego the manually-operated aspect of a manually-operated machine tool for the sake of a computer-controlled upgrade using conversions currently known in the art. The reasons include: 1) not wanting to permanently alter the manually-operated machine tool which reduces its resale value; 2) not wanting the manually-operated machine to suffer from extraordinary wear commonly found with manual-to-computer-control conversions; 3) having an on-going requirement for a manually-operated machine tool; 4) not being able to use the machine tool should the computer-control conversion fail; and 5) computer-control conversions are usually difficult and time-consuming to install or remove.

### BRIEF DESCRIPTION OF THE DRAWINGS

FIG. 1A shows a front view of an exemplary vertical milling machine.

FIG. 1B shows a side view of an exemplary vertical milling machine.

FIG. 2 shows an exemplary lathe machine.

FIG. 3A shows an exemplary dovetail machine tool guideway.

FIG. 3B shows an exemplary V-shaped machine tool guideway.

FIG. 3C shows an exemplary box-shaped machine tool guideway.

FIG. 3D shows an exemplary inverted box-shaped machine tool guideway.

FIG. 4 shows one embodiment of a modern guideway.

FIG. 5A shows an exemplary single dovetail guideway.

FIG. 5B shows an exemplary double dovetail guideway.

FIG. 5C shows an exemplary single box guideway.

FIG. 5D shows an exemplary double box guideway.

FIG. 5E shows an exemplary single V-shaped guideway.

FIG. 5F shows an exemplary double V-shaped guideway.

FIG. 5G shows an exemplary single inverted box guideway.

FIG. 511 shows an exemplary double inverted box guideway.

FIG. 6A shows an exploded view of one embodiment of a conversion assembly.

FIG. 6B shows a partially exploded view of one embodiment of a conversion assembly with double dovetail adaptors placed in mating contact with a guideway of a manually operated machine tool.

FIG. 6C shows the exemplary conversion assembly of FIG. 6B with the support surface attached to the double dovetail adaptors.

FIG. 7 shows one embodiment of modern guideways attached to double dovetail adaptors, which are connected by biasing means.

FIG. 8 shows one embodiment of a single V-shaped adaptor with an embodiment of a biasing means.

FIG. 9 shows one embodiment of a vertical milling machine with dovetail guideways.

FIG. 10 shows the vertical milling machine of FIG. 9 with a double dovetail conversion assembly attached.

FIG. 11 shows a perspective view of an embodiment of a multi-piece conversion assembly.

### DETAILED DESCRIPTION OF THE PREFERRED EMBODIMENTS

With reference to the drawings, the machine tool conversion assembly will now be described with regard for the best mode and the preferred embodiments. The embodiments disclosed herein are meant for illustration and not for limitation of the inventive scope. An ordinary practitioner will appreciate that it is possible to create many variations of the following embodiments without undue experimentation.

The terms “lathe”, “mill”, and “grinder” are used throughout this disclosure for the purpose of referencing applications of the conversion assembly, but these terms are not intended to limit the manually-operated machine tools that can benefit from application of the present conversion assembly. Further, many machine tools may be referred to by names different than these, but in fact perform the same functionality. The present conversion assembly may be applied to many if not all of these machine tools as well. Moreover, in manufacturing sectors there exists machinery which borrows its design from the machine tool industry. Such machinery may also benefit from use of the present conversion assembly for the aforementioned reasons.

Generally, the conversion assembly 10 disclosed herein comprises one or more adaptors 62 and one or more modern guideways 40. The adaptors 62 are configured for mating with one or more guideways 63 on a manually-operated machine tool, as described in more detail below. In one embodiment, the modern guideway 40 is connected directly to the one or more adaptors 62. In another embodiment, a support surface 61 connects to the adaptors 62, and the modern guideways 40 attach to the support surface 61 as described in relation to certain embodiments set forth below.

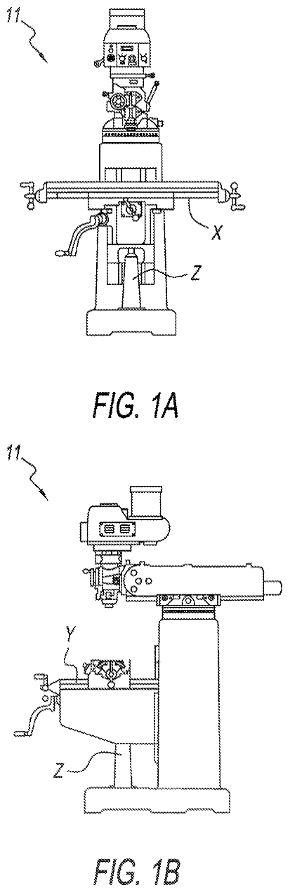

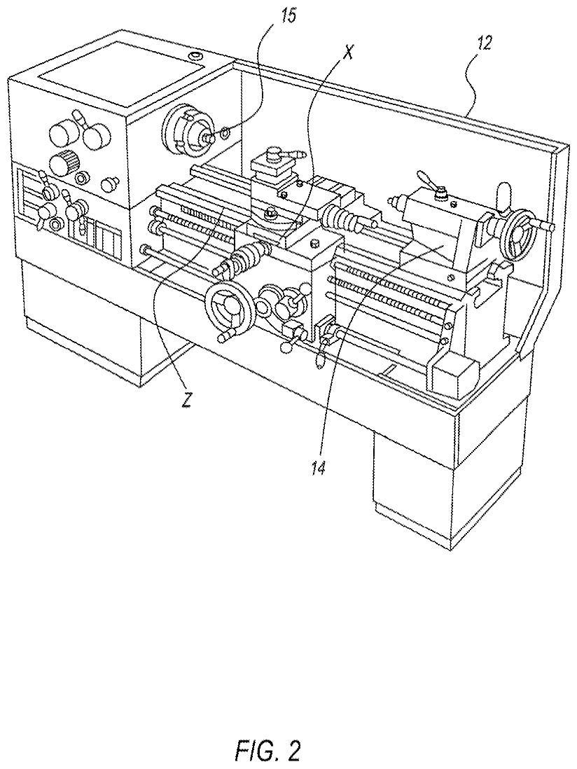

Referring to FIGS. 1 and 2, two representative examples of manually-operated machine tools, the vertical milling machine 11 (FIG. 1), and the lathe 12 (FIG. 2), are shown. The vertical milling machine 11 typically has three axes, which are referred to by the letters X, Y, and Z in FIG. 1. The manual lathe 12 typically only has two axes, Z and X, shown in FIG. 2. Accessories exist for adding a Y axis to the manual lathe 12, but this is uncommon. The tailstock 14, is a common accessory and is used to hold workpieces which may otherwise circularly “whip” when turned in the spindle 15. The tailstock 14 passively holds the workpiece's end which is opposite the end held by the spindle 15.

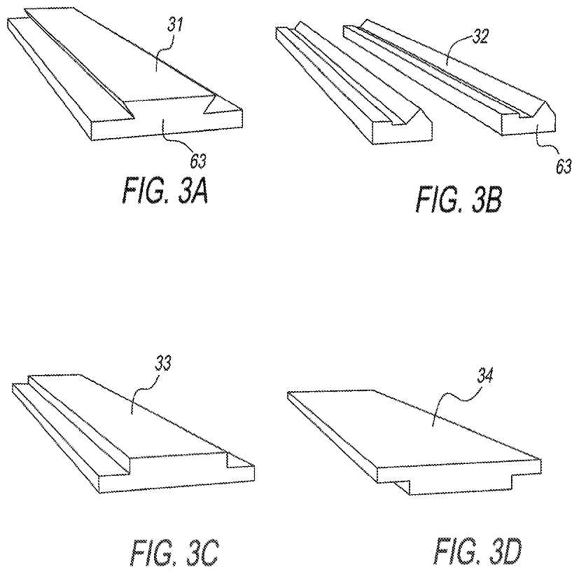

Referring to FIGS. 3A-3D, example guideways 63 are shown. The dovetail 31 is the most prevalent guideway 63 for manual milling machines 11. The V-shaped guideway 32 is the most prevalent for manual lathes 12 and grinders. Heavier-duty manual machines often use the box 33 or the inverted box 34 guideways 63. Over the years, manufacturers have used these guideways in various formats. For example, a common lathe configuration is one V-shaped guideway 63 and one box-shaped guideway 63. Many surface grinders have been manufactured with one inverted V-shaped guideway 63 and one flat guideway 63. The V-shaped guideway 63 maintains accuracy and the flat, box-shaped guideway 63 simply bears load. Square or rectangular-shaped guideways 63 are cheaper to manufacture than V-shaped guideways 63, so manufacturers often try to reduce the number of V-shaped guideways 63 or not use them at all. Many machine tools have been built utilizing various combinations of guideways 63. Over the years, it was learned that some guideway formats are better for certain types of work than others. The conversion assembly 10 described herein is capable of mating with any combination of these guideways 63.

Various embodiments of the conversion assembly 10 may comprise a plurality of guideway adaptors 62, each of which may be configured for engagement of a different shape of guideway 63. For example, one embodiment of a conversion assembly 10 comprises a first guideway adaptor 62 configured for mating engagement with a V-shaped guideway 63 and a second guideway adaptor 62 configured for mating engagement with a box-shaped guideway 63. In other words, the conversion assembly 10 may have a first guideway adaptor 62 configured for mating engagement of a guideway 63 having a first shape, and a second guideway adaptor 62 configured for mating engagement of a guideway 63 having a second shape, the first shape being different than the second shape.

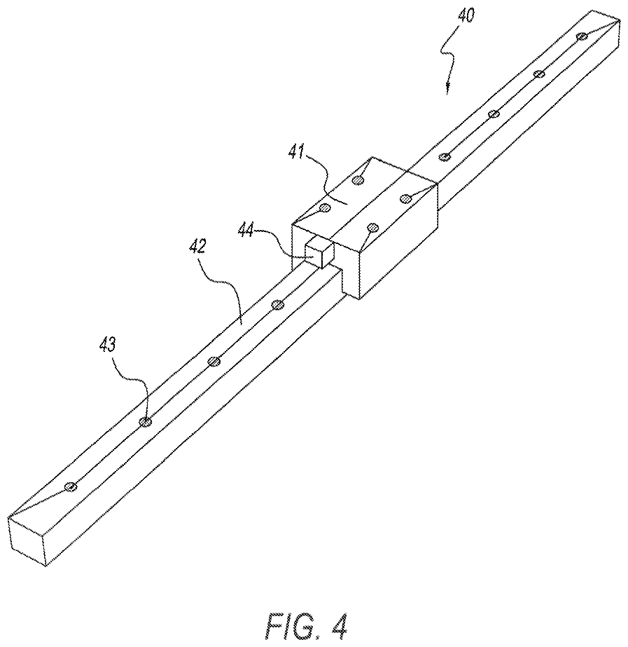

Referring to FIG. 4, one embodiment of a modern guideway 40 is shown. The specially-ground and shaped modern guideway bar 42, or rail, provides a precision travel surface for the skate 41. The skate 41 uses a means for sliding along the modern guideway bar 42, the sliding means comprising a ball-bearing design, a roller design, a rail design, or an equivalent design that minimizes contact with the modern guideway bar 42, thereby greatly reducing friction between the modern guideway bar 42 and the skate 41. The sliding means may comprise pneumatic or hydraulic functionality to assist in movement of the skate 41 along the modern guideway bar 42. The equally-spaced holes 43 are provided to receive mechanical fasteners to fasten the modern guideway bar 42 to a precision flat surface, such as the adaptors 62 of the conversion assembly 10. The skate 41 also includes a fluid port 44 for easily delivering lubricant, hydraulic fluid, or pneumatic gasses to the sliding means. Unlike manually-operated machine tools' guideways 63, such as those shown in FIG. 3A-3D, the modern guideway 40 is easily replaced when worn.

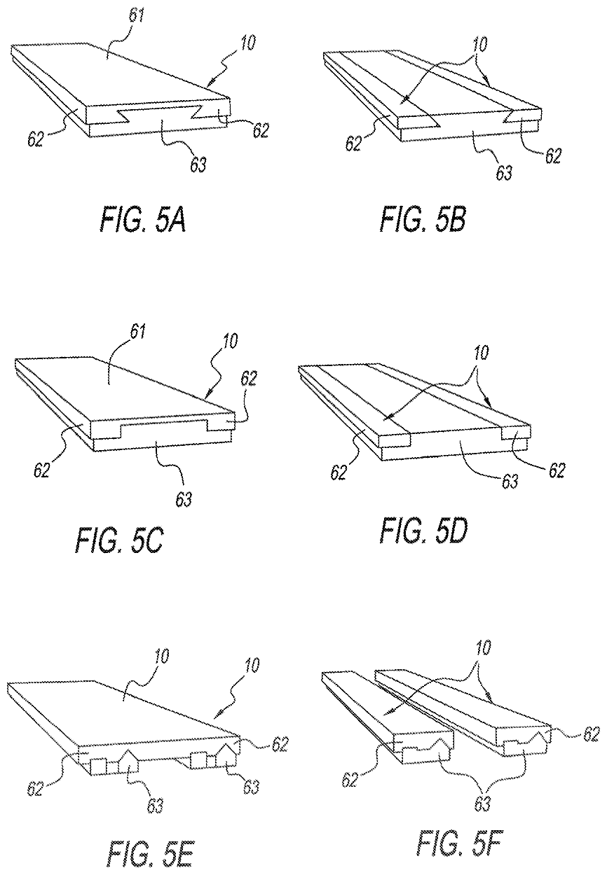

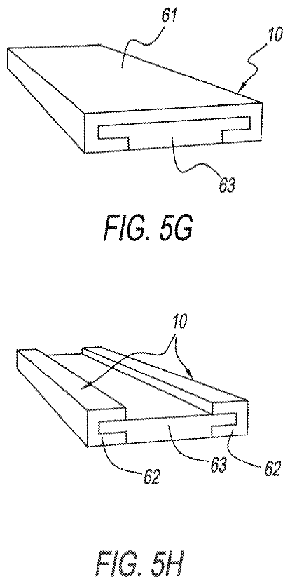

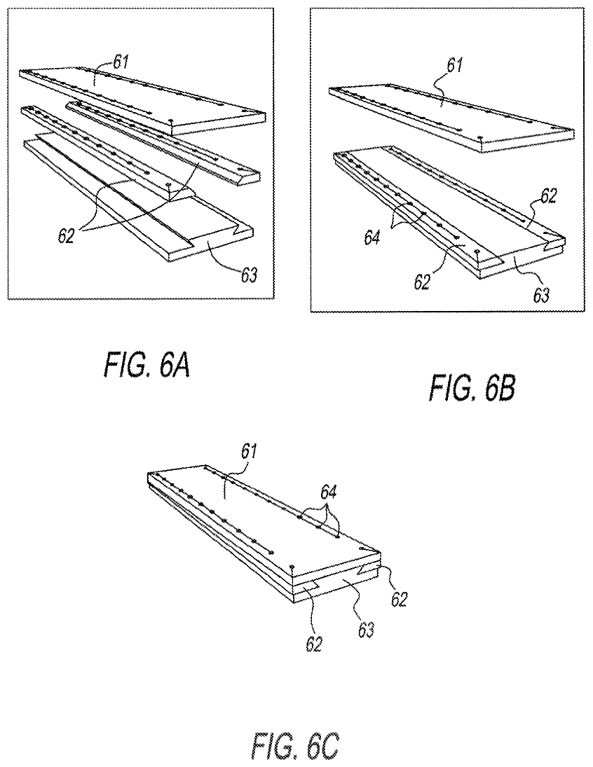

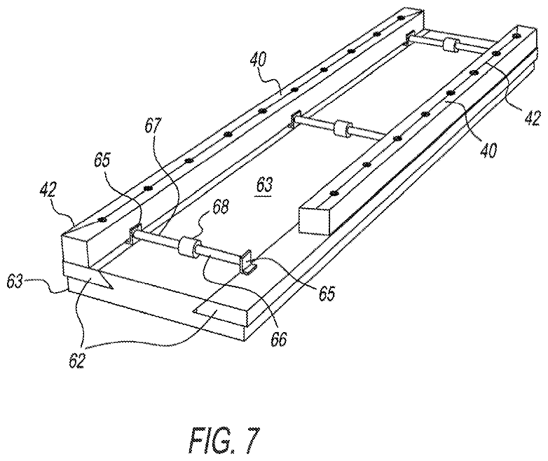

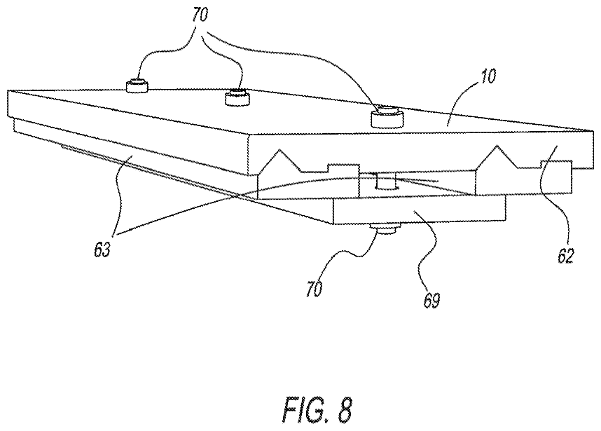

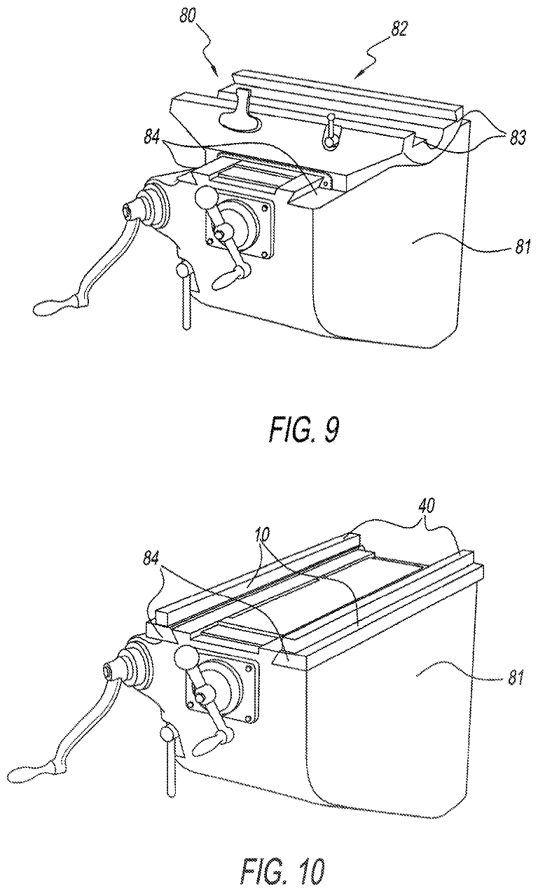

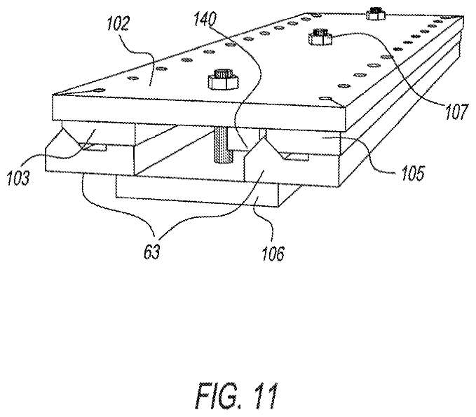

Referring to FIGS. 5A-5H, example conversion assemblies 10 are shown. For various reasons, the number of conversion assembly 10 components may vary in order to successfully convert an axis for receiving modern guideways 40. Each guideway adaptor 62 is configured for mating with one or more guideways 63 on the manually-operated machine tool. The mating configuration should correspond to the shape of the existing guideway 63, and the mating configuration should have a tolerance suitable to engage the guideways 63 of the manually-operated machine tool to sustain its accuracy and repeatability.

FIG. 5A shows one embodiment of a conversion assembly 10 support surface 61 and two adaptors 62 that are configured for mating with a single dovetail-shaped guideway 63 of a manually-operated machine tool.

FIG. 5B shows one embodiment of conversion assembly 10 adaptors 62 that are configured for mating with a double dovetail-shaped guideway 63 of a manually-operated machine tool.

FIG. 5C shows one embodiment of a conversion assembly 10 support surface 61 and two adaptors 62 that are configured for mating with a single box-shaped guideway 63 of a manually-operated machine tool.

FIG. 5D shows one embodiment of conversion assembly 10 adaptors 62 that are configured for mating with a double box-shaped guideway 51 of a manually-operated machine tool.

FIG. 5E shows one embodiment of a conversion assembly 10 support surface 61 and two adaptors 62 that are configured for mating with a single V-shaped guideway 51 of a manually-operated machine tool.

FIG. 5F shows one embodiment of conversion assembly 10 adaptors 62 that are configured for mating with a double V-shaped guideway 51 of a manually-operated machine tool.

FIG. 5G shows one embodiment of a conversion assembly 10 support surface 61 and two adaptors 62 that are configured for mating with a single inverted box-shaped guideway 51 of a manually-operated machine tool.

FIG. 5H shows one embodiment of conversion assembly 10 adaptors 62 that are configured for mating with a double inverted box-shaped guideway 51 of a manually-operated machine tool.

Referring to FIGS. 6A-6C, an example of the conversion assembly 10 constructed using multiple components is shown. The support surface 61 upon which the modern guideways 40 can be affixed is shown. Conforming to the particular manual-machine tools' guideways 63, the remainder of the conversion assembly 10 comprises one or more adaptors 62. The conversion assembly 10 is placed upon the manually-operated machine tool's guideways 63 in a “stacking” manner. Referring to FIG. 6B, the guideway adaptors 62 are shown installed upon the manually-operated machine tool's guideways 63. FIG. 6C shows the modern guideway's 40 surface 61 affixed to the guideway adaptors 62 using one or more mechanical fasteners 64.

One aspect of the conversion assembly's 10 function is to provide an interface between the original manually-operated machine tool's guideways 63 and the modern guideways 40 most often used in computer-controlled machine tools. Manually-operated machine tool's guideways 63 are generally very precise in their flatness and perpendicularity. The conversion assembly 10 relays this preciseness and perpendicularity (by way of its construction requirement of precise parallelism) for the benefit of the modern guideways 40 and the machine tool's continued accuracy.

Referring to FIG. 7, an example of a clamping system is shown. This embodiment of an exemplary clamping system comprises a double dovetail guideway 63 in a manually-operated machine tool design (see, e.g., FIG. 5B). The double dovetail conversion assembly 10 is shown installed on the dovetail guideway 63 of a manually-operated machine tool. FIG. 7 also shows the modern guideway 40 affixed to the adaptors 62 of the conversion assembly 10. Mounts 65 are affixed to the adaptors 62. In this embodiment, the adaptors 62 are connected to each other by a means for applying a bias force, or axial force, to the adaptors 62. The biasing means is configured for applying a compressive force or a separating force to the adaptors 62, thereby drawing the adaptors 62 together or spreading them apart, respectively, to promote the mating engagement between the adaptors 62 and the guideway 63. For example, in FIG. 7, the biasing means draws the adaptors 62 together, thereby compressing them against the dovetail-shaped guideway 63 in a mating engagement.

In this manner, the compressive or separating bias enables the adaptors 62, and therefore the conversion assembly 10, to removably engage the guideways 63 in a nondestructive manner. Without this nondestructive connection between the adaptors 62 and the guideways 63, the adaptors 62 would have to be connected to the manually operated machine tool using destructive means, such as by welding or by cutting the manually operated machine tool, whether the cutting is by milling, grinding, drilling (or other rotary cutting action), or by cutting grooves or notches in the manually-operated machine tool. Since the present adaptors 63 avoid these types of destructive connections, the conversion assembly 10 can be used to preserve the integrity of the original manually-operated machine tool, thereby enabling a converted CNC machine to be nondestructively re-converted back into its original state as a manually-operated machine tool.

In one embodiment of the biasing means, shown in FIG. 7, a plurality of threaded rods 66, 67 are installed on each of the two mounts 65. One threaded rod 66 is left-hand threaded and the other threaded rod 67 is right-hand threaded. A threaded nut 68 joins the two threads of the threaded rods 66, 67 due to the fact that a first portion of the nut's internal threads are threaded for left-hand threads, and a second portion of the nut's internal threads are threaded for right-hand threads. By turning this nut, the conversion assemblies 10 may be pulled into the dovetail guideway 63 of the or pushed away from them. This “dual-threaded rods and nut assembly” is commonly known as a “turnbuckle” and is used in myriad applications to quickly and easily draw two objects toward each other or to force two objects away from each other. Furthermore, it is a symmetrical design which enables the “handedness” to be oriented in either direction. Using this clamping system, no modifications to the manually-operated machine tool are necessary. The actual placement of the clamping system varies and is dependent upon the style and format of the manually-operated machine tool to be converted by the conversion assembly 10. Furthermore, the number of clamping systems or biasing means required may vary between installations even of the same machine type and size.

Referring to FIG. 8, another example of a clamping system is shown. The example uses a single V-shaped design (see, e.g., FIG. 5E). The manually-operated machine tools' guideways 63 are shown with a single V conversion assembly 10 installed upon them. In this example, and common on manual lathes 12, there is a substantial gap between the manually-operated machine's original guideways 63. This gap is provided for a device known as a tailstock 12 (see FIG. 2) which is a common accessory on a manual lathe 12. The tailstock 14 straddles the manual lathe's 12 guideways 63 and is manually positionable along the Z axis of the manual lathe 12. The conversion assembly 10 takes advantage of this gapped feature of a typical manual lathe's 12 guideways 63. The biasing means comprises a clamping bar 69 or plate that is placed underneath the manual lathe's guideways 63. Clamping fasteners 70 are used to clamp the conversion assembly 10 and the clamping bar 69 together. This tensile force delivered by the biasing means provides significant surface tension and provides a surface suitable for modern guideways 40. Furthermore, the number of clamping fasteners 70 required may vary between installations, even of the same machine type and size.

Referring to FIG. 9, a typical component on a vertical milling machine 80 known as the “knee” 81 is shown. The knee 81 is raised and lowered to produce the axis referred to as Z. Manufactured into the knee 81 are dovetail guideways 84 which provide guideways to enable a saddle 82 to slide to and fro in the dovetail guideways 84, which enables saddle movement parallel to the Y axis. Also, the saddle 82 provides an additional pair of saddle guideways 83, which are perpendicularly-oriented to the Y axis, usually referred to as the X axis.

FIG. 10 shows the vertical milling machine 80 of FIG. 9 with the saddle 82 removed. The dovetail guideways 84, which normally enable Y-axis travel of the saddle 82, are instead fitted with conversion assemblies 10. Upon the conversion assemblies 10, modern guideways 40 are shown.

Another embodiment enables more practical manufacturing of guideway adaptors 62 for certain manual machine tools. Referring now to FIG. 11, a common guideway 63 for a lathe 12 is shown. Because the distance between the lathe's 12 guideways 63 will vary depending upon the size and style of lathe 12, separating the conversion assembly 10 makes producing and fitting easier for both the manufacturer and the installer. In this example, the conversion assembly 10 is four separate members: the base 102, the forward guideway adaptor 103, the rear guideway adaptor 105, and an accuracy stabilizing guideway adaptor 104. In the preferred embodiment, the conversion assembly 10 is held in place on the manual lathe using a biasing means that has a clamping plate 106 and a plurality of clamping fasteners 107 compress the base 102 and the clamping plate 106 together. The clamping action of the biasing means produces an axial force in the clamping fasteners 107, which compresses the base 102, the forward guideway adaptor 103, the stabilizing guideway adaptor 104, and the rear guideway adaptor 104 against the guideways 63 of the lathe 12. This compressive contact between the respective guideway adaptors 103, 105, 105 and the guideways 63 retains these members in a nondestructive, mating engagement. In this exemplary embodiment, the stabilizing guideway adaptor 104 is coupled with the rear guideway adaptor 105 to engage the guideways 63 on the lathe 12. This coupling of the stabilizing guideway adaptor 104 and the rear guideway adaptor 105 stabilizes the accuracy and repeatability that is delivered by the conversion assembly 10. Alternately, the stabilizing guideway adaptor 104 could be coupled to the forward guideway adaptor 103 in the same manner for the same purpose.

In this embodiment, it may be preferable to use the tailstock's 14 mounting seat to secure the clamping plate 106 of the biasing means. However, in certain machine tools this is not available or practical. In such cases, clamps are installed such that other surfaces of the lathe's 12 guideways 63 may be used as clamping locations for the biasing means. This latter arrangement may not be as suitable because the tailstock's 14 clamping bar seat is generally a machined surface, while other sections of the lathe's 12 guideways 14 are generally left as they were when they were cast.

In one embodiment, the conversion assembly 10 components are made from tool steel, hardened, and precision-ground for parallelism. The conversion assembly 10 components are also prepared to accept modern guideways 40. To facilitate the various manually-operated machine tools, the conversion assembly 10 components may include other features such recesses, notches, holes, slots, and bosses. Therefore, the conversion assembly 10 may be thought of as providing an “interface” to the manually-operated machine tools' guideways 63 as well as an “interface” to modern guideways 40 while completely preserving and protecting the manually-operated machine tools' castings and components.

In one embodiment, manually-operated machine tools which are considered to be too worn-out to be of service, may in fact be completely restored to valuable service through application of the conversion assembly 10.

In another embodiment, which calls for the conversion assembly 10 to be made from tool steel, hardened, and precision-ground, flaws resulting from prior manual usage may be “averaged out” and have no adverse effect on the guideway conversion as a whole. In fact, manually-operated machines with excessive wear may be completely restored using the conversion assembly 10.

Although conversion assemblies 10 in some embodiments are affixed to the machine tool using non-destructive biasing means (such as clamps which produce either compressive or tensile forces and/or the re-purposing of existing holes of the manually-operated machine tool), another embodiment of affixing the adaptors 62 to the guideways 63 provides for affixing the conversion assembly 10 by drilling into the original machine tool into which bolts or screws are used in lieu of clamps. This may be limited to particular guideway(s) which otherwise may be impossible to clamp. In the latter case, it is completely reasonable that such hole locations would be chosen so as to not adversely affect the operation of the manually-operated machine tool after the conversion assembly 10 is removed. After removal of the conversion assembly 10, such holes may be blocked using round or threaded plugs. Such plugs would also protect and preserve the holes for the re-installation of the conversion assembly 10. However, drilling the castings of a manually-operated machine tool is discouraged because castings tend to be designed very specifically for their purpose and do not have “extra” material for load bearing, and the precision surfaces themselves are usually hardened which makes drilling or tapping very difficult and costly. The process of drilling and tapping hardened surfaces might also fail. Therefore, a biasing means that uses clamping and either tensile forces or compressive forces, or a combination of both, is the preferred embodiment.

The foregoing embodiments are merely representative of the machine tool conversion assembly and not meant for limitation of the invention. For example, persons skilled in the art would readily appreciate that there are several embodiments and configurations of guideways, clamping means, and other components will not substantially alter the nature of the conversion assemblies. Likewise, elements and features of the disclosed embodiments could be substituted or interchanged with elements and features of other embodiments, as will be appreciated by an ordinary practitioner. Consequently, it is understood that equivalents and substitutions for certain elements and components set forth above are part of the invention described herein, and the true scope of the invention is set forth in the claims below.

We claim:

1. A conversion assembly for retro-fitting a manually operated machine tool guideway, the conversion assembly comprising:
a plurality of guideway adaptors configured for nondestructive mating with one or more machine tool guideways on a manually operated machine tool, the plurality of guideway adaptors connected by a biasing means that engages at least one of the plurality of guideway adaptors in a compressive or in a separating bias; and
wherein the plurality of guideway adaptors are configured for mating with a dovetail-shaped, a V-shaped, flat-shaped, or a box-shaped guideway of the manually-operated machine tool.

2. The conversion assembly of claim 1, wherein the biasing means comprises a turnbuckle assembly.

3. The conversion assembly of claim 1, wherein the biasing means comprises a clamping bar and one or more clamping fasteners.

4. The conversion assembly of claim 1, where in the plurality of guideway adaptors comprises a forward guideway adaptor, a stabilizing guideway adaptor, and a rear guideway adaptor.

5. The conversion assembly of claim 3, where in the plurality of guideway adaptors comprises a forward guideway adaptor, a stabilizing guideway adaptor, and a rear guideway adaptor.

6. The conversion assembly of claim 4, wherein the stabilizing guideway adaptor is coupled to the forward guideway adaptor or to the rear guideway adaptor for mating engagement with one guideway of the manually operated machine tool.

7. The conversion assembly of claim 5, wherein the stabilizing guideway adaptor is coupled to the rear guideway adaptor for mating engagement with one guideway of the manually operated machine tool.

8. The conversion assembly of claim 1, wherein the plurality of guideway adaptors further comprises:
a first guideway adaptor configured for mating engagement of a manually operated machine tool guideway having a first shape; and
a second guideway adaptor configured for mating engagement of a manually operated machine tool guideway having a second shape, the first shape being different than the second shape.

9. The conversion assembly of claim 8, wherein the biasing means comprises a turnbuckle assembly.

10. The conversion assembly of claim 8, wherein the biasing means comprises a clamping bar and one or more clamping fasteners.

11. The conversion assembly of claim 8, where in the plurality of guideway adaptors comprises a forward guideway adaptor, a stabilizing guideway adaptor, and a rear guideway adaptor.

12. The conversion assembly of claim 10, where in the plurality of guideway adaptors comprises a forward guideway adaptor, a stabilizing guideway adaptor, and a rear guideway adaptor.

13. The conversion assembly of claim 11, wherein the stabilizing guideway adaptor is coupled to the rear guideway adaptor for mating engagement with one guideway of the manually operated machine tool.

14. The conversion assembly of claim 12, wherein the stabilizing guideway adaptor is coupled to the rear guideway adaptor for mating engagement with one guideway of the manually operated machine tool.
